(19) United States
(12) Patent Application Publication
(10) Pub. No.: US 2016/0164696 A1
(43) Pub. Date: Jun. 9, 2016

(54) MODULAR INTERNET OF THINGS

(71) Applicants: Han-Shen Yuan, Sunnyvale, CA (US); Steve Yankovich, San Jose, CA (US)

(72) Inventors: Han-Shen Yuan, Sunnyvale, CA (US); Steve Yankovich, San Jose, CA (US)

(73) Assignee: eBay Inc., San Jose, CA (US)

(21) Appl. No.: 14/963,084

(22) Filed: Dec. 8, 2015

Related U.S. Application Data
(60) Provisional application No. 62/089,157, filed on Dec. 8, 2014.

(51) Int. Cl. H04L 12/28; H04L 29/08

(52) U.S. Cl. CPC H04L 12/2816; H04L 67/12

(57) ABSTRACT

Methods and systems for enabling a modular internet of things are disclosed. A central component detects one or more specialist devices in the area proximate to the central component. In response to detecting a first specialist device, the central component initiates a connection with the specialist device. The central component accesses a list of capabilities associated with the first specialist device. The central component initiates a first task, which includes one or more specific task responsibilities, and allocates one or more specific task responsibilities between the central component and the first specialist device based at least in part on the list of capabilities associated with the first specialist device.

### RELATED APPLICATION

This application claims the benefit of priority to U.S. Provisional Application No. 62/089,157, filed on Dec. 8, 2014, which is hereby incorporated by reference herein in its entirety.

This application relates generally to the field of electronic devices and specifically to portable devices.

### BACKGROUND

The rise in electronic and digital device technology has rapidly changed the way society interacts with media and consumes goods and services. Digital technology enables a variety of consumer devices to be available that are very flexible and relatively cheap. Specifically, modern electronic devices, such as smart phones and tablets, allow a user to have access to a variety of useful applications even when away from a traditional computer.

However, because many of the portable electronic devices include a wide variety of functionality, it is possible, or even sometimes likely, that a given user will have more than one portable electronic device on hand at a given time and this will result in redundant functionality between devices. For example, a user with a smart phone, a smart watch, and a tablet will likely have picture taking functionality on all three devices.

In addition, even if a user only carries a single portable electronic device, much of the functionality available will not be used at any given time. This can result in excess battery usage (e.g., running the battery to keep in contact with the cellular network when the user is only playing offline games) or extra burden on a processor that reduces processor capacity for the user's current task.

### BRIEF DESCRIPTION OF THE DRAWINGS

The present description is illustrated by way of example, and not by way of limitation, in the FIGS. of the accompanying drawings, in which:

FIG. 1 is a block diagram illustrating a central device in a modular internet of things, in accordance with some embodiments.

FIG. 2 is a block diagram illustrating a central device, in accordance with some embodiments.

FIG. 3 is a block diagram illustrating a peripheral component, in accordance with some embodiments.

FIG. 4 is a flow diagram illustrating a process for allowing a central device to interface with a specialist device in a modular internet of things, in accordance with some embodiments.

FIGS. 5A-5C are flow diagrams illustrating a process for allowing a central device to interface with a specialist device in a modular internet of things, in accordance with some embodiments.

FIG. 6 is a block diagram illustrating an architecture of software that may be installed on any one or more of devices of a computer system.

FIG. 7 is a block diagram illustrating components of a machine, according to some example embodiments.

Like reference numerals refer to corresponding parts throughout the drawings.

### DETAILED DESCRIPTION

Although the embodiments will be described with reference to specific example embodiments, it will be evident that various modifications and changes may be made to these embodiments without departing from the broader spirit and scope of the description. Accordingly, the specification and drawings are to be regarded in an illustrative rather than a restrictive sense.

Many consumer electronic devices (especially portable personal devices) are intentionally designed to include as many different functions and capabilities as possible. Many smart phones include so many features that they are rarely used to place telephone calls. For example, a smart phone may include a camera, a GPS device, Wi-Fi connection devices, a large touch screen, one or more fitness trackers, large memory storage, a relatively powerful processor, a large battery, multi-media presentation capability, a word processor, a text interface, and so on. Similarly, tablet computers, smart watches, and other personal electronics will also include many if not all of these same features. Thus, users who carry multiple personal computing devices will have the same functionality duplicated multiple times across those different devices with little or no benefit to the user.

Additionally, most users will only use a few of these features at one time. For example, it is unlikely that a user will be using the camera, the word processor, and a heartbeat monitor simultaneously. Thus, the personal electronic device is using battery life and processor bandwidth to provide simultaneous access to many feature and capabilities that the user may rarely or never use simultaneously.

One solution is to reduce duplication of features by extracting the hardware needed to provide key features from the multiple different electronic devices and instead enabling that hardware in a single device discrete device which would then act as a central device in a modular system of devices that can interconnect. For example, a central device can contain memory, network communication, extra processing power, and battery life that all peripheral devices can access and benefit from without having that functionality replicated in hardware for each device.

The central device can then support a many different specialized peripheral devices. For example, rather than having a camera built into a smart phone, the central device can support a camera peripheral that includes only camera specific components (e.g., a lens, image capture technology, and the ability to transfer the captured image over a personal area network to the central device).

The central devices concerned with storing and processing the image and later transferring it over a network to be edited, shared, and/or printed. Because peripherals only need to include specialized hardware, users can select which functionality is most important and then purchase better quality parts for the purpose. Users can also avoid paying for unwanted capabilities altogether.

Additionally, third parties (e.g., coffee shops) can also provide peripherals for their users to use and access for a much reduced price. For example, a coffee shop or bookstore can provide display screens that are able to connect (either wireless or otherwise) to central devices brought by customers and without other functionality. Then customers of the coffee shop or bookstore can access data on their central device using the provided screens without having to bring a laptop/tablet of their own. Indeed, the screens can act as personal devices because the central devices the users bring can include personalized settings that are then used by the display screens to determine what the user interface looks like and what data is available.

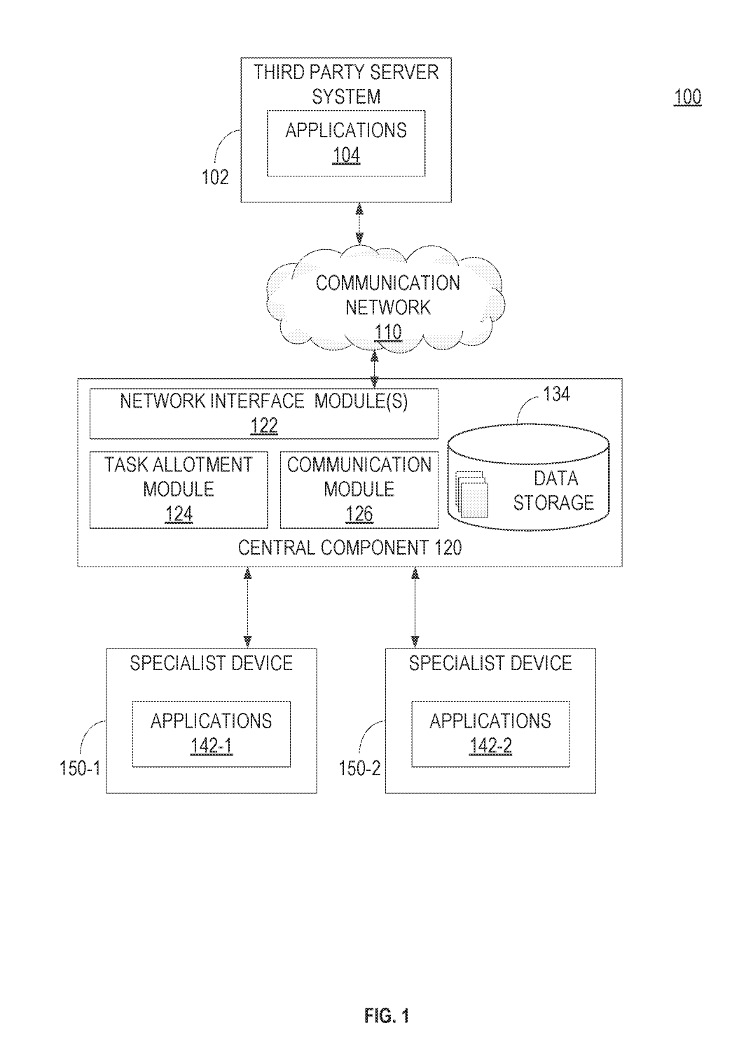

FIG. 1 is a block diagram illustrating a central device 120 in a modular internet of things system 100 that connects to one or more specialist devices 150-1 and 150-2. A specialized device is a device that includes as few components as necessary to perform one or a limited set of tasks well. One or more communication networks 110 interconnect the central device 120 to one or more third-party server systems 102. The communication network 110 may be any of a variety of networks, including local area networks (LAN), wide area networks (WAN), wireless networks, wired networks, the Internet, personal area networks (PAN), or a combination of such networks.

In some example embodiments, the one or more third-party server systems 102 are one or more electronic devices with one or more processors, memory, and applications 104, that can communicate over the communication network 110 to provide services to other electronic devices. The one or more third-party server systems 102 receive requests over the communication network 110. The applications 104 process the requests and send responses back over the communication network 110.

In some example embodiments, the central device 120 is an electronic device that includes functionality that is common to many personal computing devices. In this case the central device 120 includes a network interface module a task allotment module 124, a communication module 126, and a data storage device 134. The central device 120 also includes one or more processors and memory for storing programs.

In some example embodiments, the central device 120 includes the network interface module(s) (e.g., a web server) 122, which sends and receives data to and from various third-party server systems 102 over the communication network 110. For example, the network interface module(s) 122 sends a web page request to a third-party server system 102 and receives the requested web page from the third-party server system 102. In some example embodiments, the network interface module(s) can be used to access web services associated with tasks at the central device 120. For example, the central device 120 can access information about the capabilities of varies specialist devices (e.g., the device 150 in FIG. 1) or access additional functionality at a third party system.

In some example embodiments, the task allotment module 124 divides the work to accomplish one or more tasks between the central device 120 and the specialist device 150-1 or 150-2 that has initiated the task. The task allotment module 124 receives a task request from a specialist device 150-1 or 150-2. In some example embodiments, the specialist device 150 has a limited number of capabilities that are specialized to its use (e.g., a display screen with a power source but without internet connection capabilities or data storage). The central device 120 then determines the capabilities of the specialist device 150 and the capabilities of the central device 120.

Based on the determined capabilities, the central device divides the tasks between the central device 120 and the specialist device 150. For example, if the specialist device 150 has some processing capability, the primary calculations are completed at the central device 120 but some tasks are completed at the specialist device 150 for performance concerns. In some example embodiments, the divisions are made specifically based on the different capabilities of the central device 120 and the specialist device 150.

In some example embodiments, the communication module 126 communicates with the one or more specialist devices 150-1 or 150-2. This communication is only through a direction connection or through a personal area network technology (e.g., Bluetooth technology) rather than over a local area network or the Internet. This allows the specialty devices 150 to include only the capabilities that serve the specific specialty device's 150-1 role.

In some example embodiments, the data storage device 134 is a database that stores data related to the central device 120 and its user, such that this data is available for access from specialist devices 150 that connect to the central device 120 (when the user of the central device 120 allows it). In some example embodiments, when a specialist device 150 attempts to connect to the central device 120, the central device 120 queries the user to determine whether to allow the connection. For example, the central device 120 plays a tone whenever a specialist device 150 attempts to connect to the central device 120. The user can then accept the connection by pressing an input button on the central device 120.

In some example embodiments, the data storage device 134 is also available to store date produced by a specialist device (e.g., the device 150 in FIG. 1). Thus if the specialist device (e.g., the device 150 in FIG. 1) is a camera, the captured images can be stored in the data storage device 134 if the specialist device (e.g., the device 150 in FIG. 1) does not include any storage capacity (or if the user prefers to storage data on the central device (e.g., the device 120 in FIG. 1) for ease of access.)

In some example embodiments, specialist devices 150-1 and 150-2 are devices intended to connect to the central device 120 and thus do not need to include the functionality of the central device 120. Instead, each specialist device 150-1 and 150-2 includes only the components necessary to perform the specialized function for which they are intended and then connect to the central device 120. As a result, each specialist device 150-1 and 150-2 can cost less than a fully integrated device and have higher quality components/functionality. In some example embodiments, the one or more special devices 150-1 and 150-2 include applications 142-1 and 142-2 that enable the specific capabilities of the specialist devices 150-1 and 150-2.

Examples of specialist devices 150-1 and 150-2 include but are not limited to a camera, a fitness tracker, a display device, a global positioning satellite device (GPS), a keyboard, and so on.

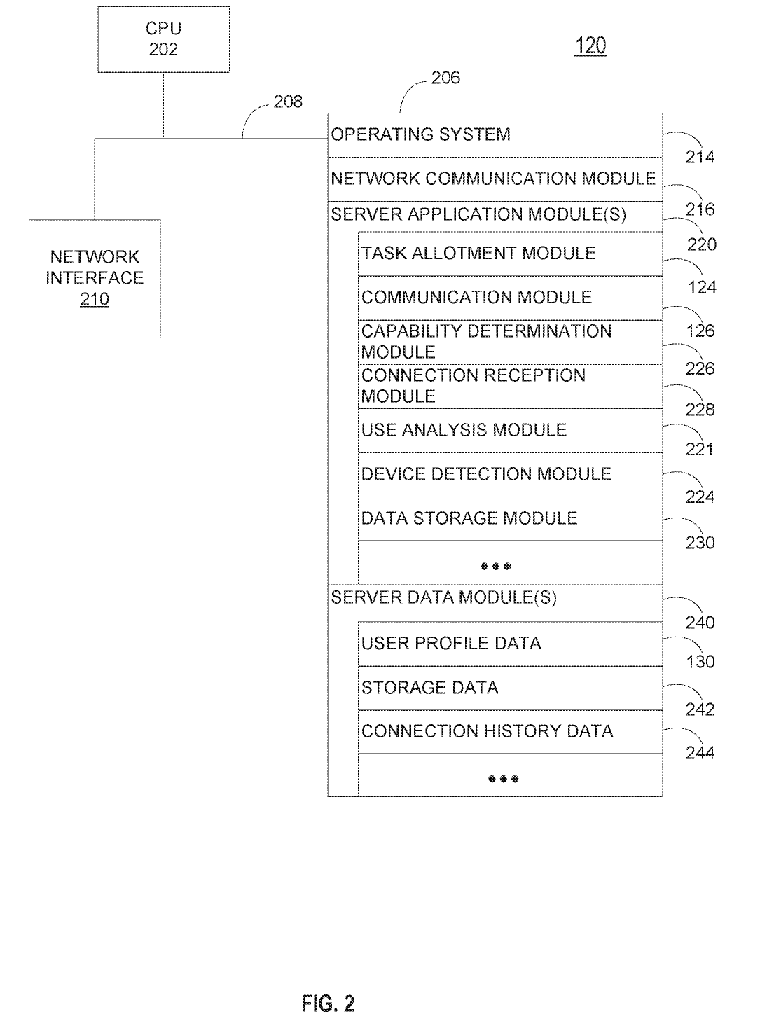

FIG. 2 is a block diagram illustrating a central device 120, in accordance with some embodiments. The central device 120 typically includes one or more central processing units (CPUs) 202, one or more network interfaces 210, memory 206, and one or more communication buses 208 for interconnecting these components. The memory 206 may include high-speed random access memory, such as DRAM, SRAM, DDR RAM, or other random access solid state memory devices, and may include non-volatile memory, such as one or more magnetic disk storage devices, optical disk storage devices, flash memory devices, or other non-volatile solid state storage devices. The memory 206 may optionally include one or more storage devices remotely located from the CPU(s) 202.

The memory 206, or alternately, the non-volatile memory device(s) within the memory 206, comprises a non-transitory computer readable storage medium. In some embodiments, the memory 206 or the computer readable storage medium of the memory 206 stores the following programs, modules, and data structures, or a subset thereof:
an operating system 214 that includes procedures for handling various basic system services and for performing hardware dependent tasks;
a network communication module 216 that is used for connecting the central device 120 to other computers via the one or more network interfaces 210 (wired or wireless) and one or more communication networks 110, such as the Internet, other WANs, LANS, MANs, and so on;
one or more server application modules 220 for performing the services offered by the central device 120, including but not limited to:
   a task allotment module 124 for, in response to receiving a task request from a specialist device (e.g., specialist devices 150-1 and 150-2 in FIG. 1), determining which aspects of the task will be performed by the central device 120 and which aspects will be performed by the specialist device (e.g., specialist devices 150-1 and 150-2 in FIG. 1);
   a communication module 126 for communicating over a short area network (e.g., a PAN) with one or more specialist devices (e.g., specialist devices 150-1 and 150-2 in FIG. 1);
   a capability determination module 226 for determining the capabilities of the specialist device (e.g., specialist devices 150-1 and 150-2 in FIG. 1) and the central device 120;
   a connection reception module 228 for receiving a connection request from a specialist device (e.g., specialist devices 150-1 and 150-2 in FIG. 1) to initiation a communication session;
   a use analysis module 221 for determining the bandwidth currently used by the central device 120;
   a device detection module 224 for determining whether there are any applicable specialist devices (e.g., specialist devices 150-1 and 150-2 in FIG. 1) in the area around the central device 120 that are available for communication; and
   a data storage module 230 for storing and retrieving data from the data storage device 134; and
server data module(s) 240, holding data related to the central device 120, including but not limited to:
   user profile data 130, including profile data regarding the user associated with the central device 120, including, but not limited to, demographic information about the user, user interest information, user history information, and any other information regarding the user;
   storage data 242, including data used by the central device 120 to facilitate interaction with one or more specialist devices (e.g., specialist devices 150-1 and 150-2 in FIG. 1) and data received from interactions with one or more specialist devices (e.g., specialist devices 150-1 and 150-2 in FIG. 1); and
   connection history data 244, including a record of one or more specialist devices (e.g., specialist devices 150-1 and 150-2 in FIG. 1) that the central device 120 has previously connected to.

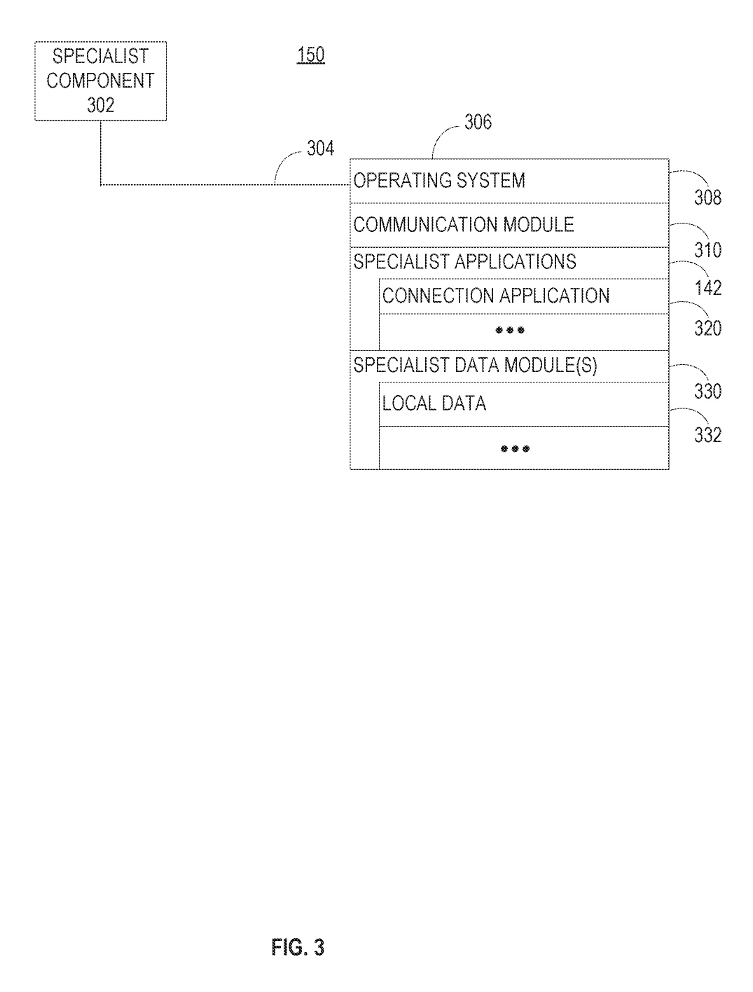

FIG. 3 is a block diagram further illustrating the specialist device 150, in accordance with some example embodiments. The specialist device 150 typically includes one or more specialist components 302 (e.g., the components necessary to perform the capabilities of the specialist device 150 such as a display screen or photography components), memory 306, and one or more communication buses 304 for interconnecting these components.

Memory 306 includes high-speed random access memory, such as DRAM, SRAM, DDR RAM or other random access solid state memory devices, and may include non-volatile memory, such as one or more magnetic disk storage devices, optical disk storage devices, flash memory devices, or other non-volatile solid state storage devices. Memory 306 may optionally include one or more storage devices remotely located from the specialist component 302. Memory 306, or alternately the non-volatile memory device(s) within memory 306, comprises a non-transitory computer readable storage medium.

In some example embodiments, memory 306, or the computer readable storage medium of memory 306, stores the following programs, modules, and data structures, or a subset thereof:
an operating system 308 that includes procedures for handling various basic system services and for performing hardware dependent tasks;
a communication module 310 used for connecting the specialist device 150 to one or more other central devices 120 via one or more communication network interfaces (wired or wireless) and one or more communication networks (e.g., communication network 110 of FIG. 1), such as the Internet, other WANs, LANs metropolitan area networks (MANs), etc.;
one or more specialist applications 142 for handling various aspects of requesting and receiving numbers, including but not limited to:
   a connection application 320 for connecting to and communicating with a central device 120 over a communication network (e.g., network 110 in FIG. 1);
specialist data module(s) 330 for storing data at the specialist device 150, including but not limited to:
   local data 332 including information stored by the specialist device 150.

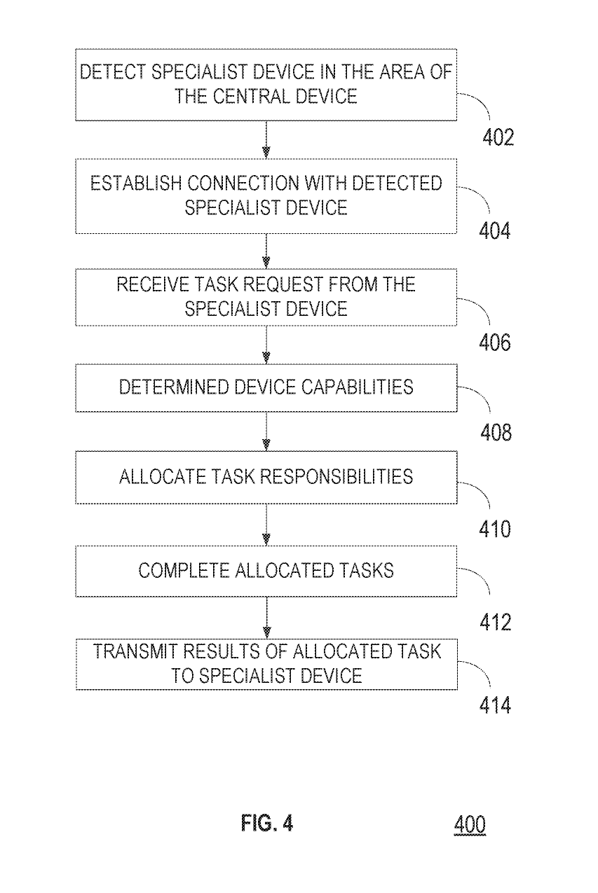

FIG. 4 is a flow diagram illustrating a method 400 for connecting a central device to a specialist device (e.g., specialist devices 150-1 and 150-2 in FIG. 1) to accomplish one or more tasks, in accordance with some embodiments. Each of the operations shown in FIG. 4 corresponds, in some embodiments, to instructions stored in a computer memory or computer readable storage medium. In some embodiments, the method 400 described with reference to FIG. 4 is performed by a server system (e.g., third-party server system 102 in FIG. 1).

The method 400 is performed at a central device (e.g., central device 120 as shown in FIG. 1) including one or more processors and memory (e.g., memory 206 as shown in FIG. 2) storing one or more programs for execution by the one or more processors. The central device (e.g., central device 120 in FIG. 1) detects (402) whether there are one or more specialist devices (e.g., specialist devices 150-1 and 150-2 in FIG. 1) in the area proximate to the central device (e.g., central device 120 in FIG. 1). For example, the central device (e.g., central device 120 in FIG. 1) repeatedly (e.g., on a fixed repeating schedule or in response to specific events such as user interaction) uses a communication module (e.g., communication module 126 in FIG. 1) to test (e.g., by a ping signal of some kind) whether any specialist devices (e.g., specialist devices 150-1 and 150-2 in FIG. 1) are nearby.

In accordance with a determination that a specialist device (e.g., specialist devices 150-1 and 150-2 in FIG. 1) is nearby, the central device (e.g., central device 120 in FIG. 1) then establishes (404) a connection with the detected specialist device (e.g., specialist devices 150-1 and 150-2 in FIG. 1). The connection allows the central device (e.g., central device 120 in FIG. 1) and the specialist device (e.g., specialist devices 150-1 and 150-2 in FIG. 1) to pass information between them.

In some example embodiments, the central device (e.g., central device 120 in FIG. 1) receives (406) a task request from the specialist device (e.g., specialist devices 150-1 and 150-2 in FIG. 1). In some example embodiments, a camera specialist device (e.g., specialist devices 150-1 and 150-2 in FIG. 1) receives input from a user requesting a picture. The camera specialist device (e.g., specialist devices 150-1 and 150-2 in FIG. 1) then communicates the requested task to the central device (e.g., central device 120 in FIG. 1).

In some example embodiments, the central device (e.g., central device 120 in FIG. 1) then determines (408) the device capabilities of both the central device (e.g., central device 120 in FIG. 1) and the specialist device (e.g., specialist devices 150-1 and 150-2 in FIG. 1). In some example embodiments, determining the device capabilities of the specialist device (e.g., the device 150 in FIG. 1) are received from the specialist device (e.g., the device 150 in FIG. 1) when the specialist device (e.g., the device 150 in FIG. 1) connects to the central device (e.g., the device 120 in FIG. 1). In other example embodiments, the central device (e.g., the device 120 in FIG. 1) receives a specialist device identification code from the specialist device (e.g., the device 150 in FIG. 1) and then contacts a third party server to look up a list of device capabilities using the identification code.

In some example embodiments, the central device (e.g., the device 120 in FIG. 1) maintains a list of possible tasks and what capabilities are required for each task. In other example embodiments, the central device (e.g., the device 120 in FIG. 1) receives the task request and the required capabilities from the specialist device (e.g., the device 150 in FIG. 1). In this way, the specialist device (e.g., the device 150 in FIG. 1) stores information on each task that can be requested from it.

In yet other example embodiments, the information on each task is stored online and is available upon request from the central device the device 120 in FIG. 1). In other example embodiments, the central device (e.g., the device 120 in FIG. 1) determines, based on the nature of the task, what capabilities are needed.

In this example, the central device (e.g., central device 120 in FIG. 1) determines that the specialist device (e.g., specialist devices 150-1 and 150-2 in FIG. 1) includes image capture technology, a lens, and a display device (e.g., a screen). The central device (e.g., central device 120 in FIG. 1) includes memory, one or more processors, and a wireless communication device.

In some example embodiments, the central device (e.g., central device 120 in FIG. 1) allocates (410) specific task responsibilities between the central device (e.g., central device 120 in FIG. 1) and the specialist device (e.g., specialist devices 150-1 and 150-2 in FIG. 1). For example, the central device (e.g., central device 120 in FIG. 1) allocates taking the picture and capturing the image to the camera device (e.g., a specialist device 150-1 or 150-2 in FIG. 1) and allocates processing and storing the image to the central device (e.g., central device 120 in FIG. 1).

In some example embodiments, the central device (e.g., central device 120 in FIG. 1) completes (412) the allocated tasks. Continuing the above example, the central device (e.g., central device 120 in FIG. 1) receives the image data from the camera, performs one or more post processing steps using the one or more processors, and then stores the resulting processed image in data storage (e.g., data storage device 134 in FIG. 1).

In some example embodiments, the central device (e.g., central device 120 in FIG. 1) transmits (414) the results of the allocated task to the specialist device (e.g., specialist devices 150-1 and 150-2 in FIG. 1) that send the original request. For example, the central device (e.g., central device 120 in FIG. 1) sends the processed image to the camera device for display.

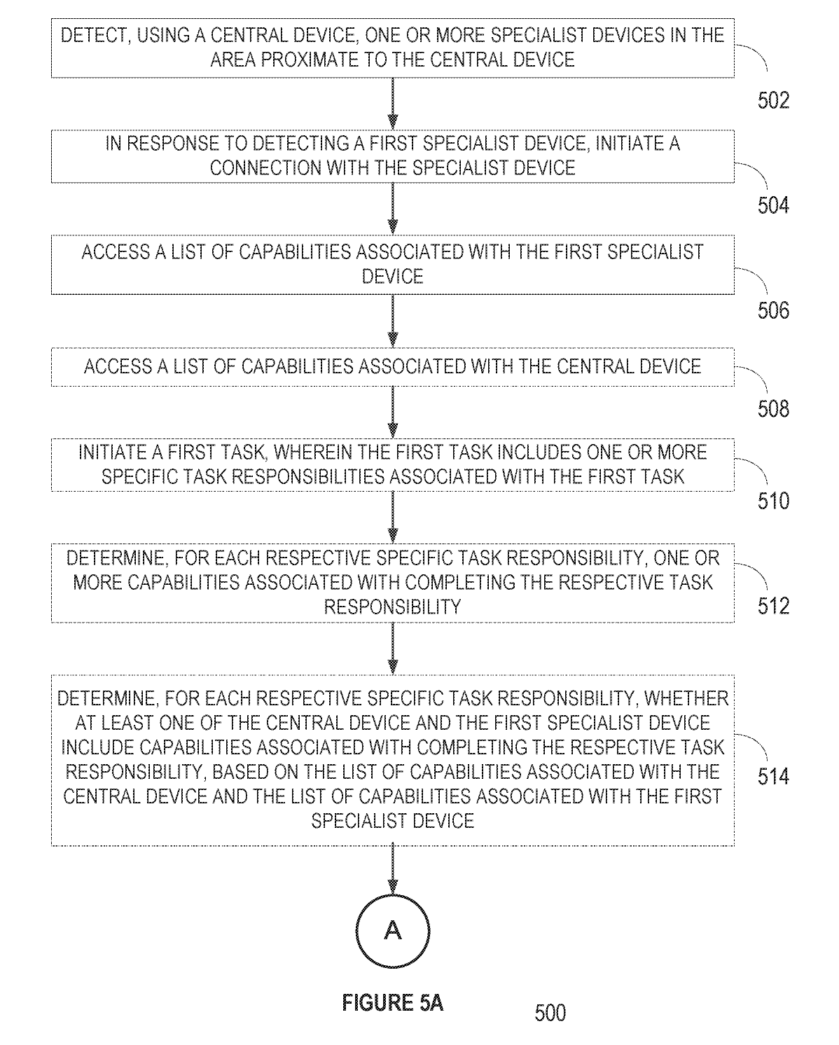

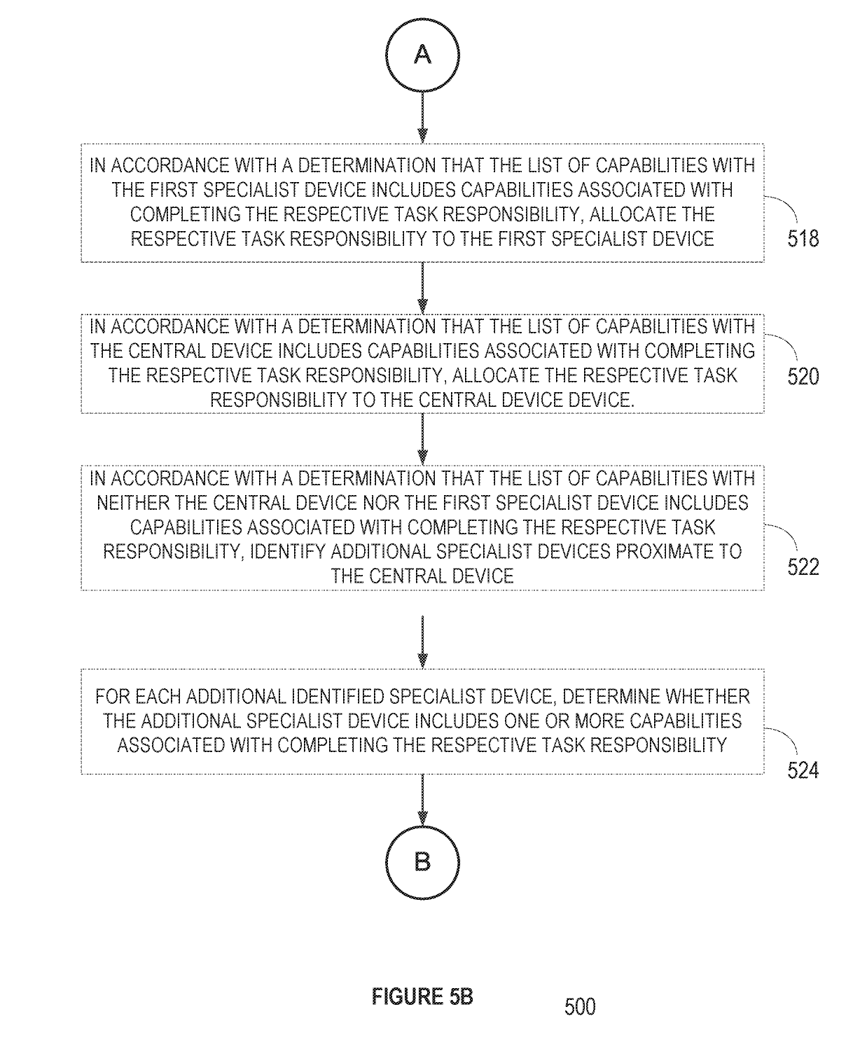

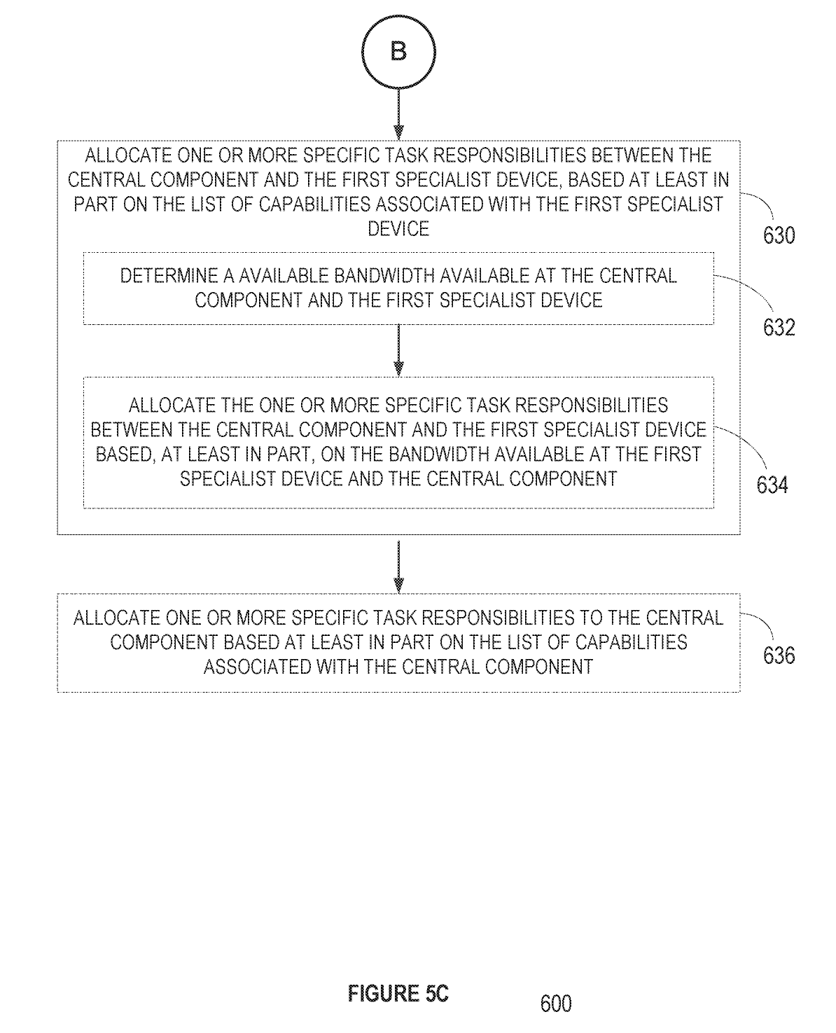

FIG. 5A is a flow diagram illustrating a method, in accordance with some example embodiments, for connecting a central device to a specialist device (e.g., specialist devices 150-1 and 150-2 in FIG. 1) to accomplish one or more tasks, in accordance with some embodiments. Each of the operations shown in FIG. 5A may correspond to instructions stored in a computer memory or computer-readable storage medium. Optional operations are indicated by dashed lines (e.g., boxes with dashed-line borders). In some embodiments, the method described in FIG. 5A is performed by the central device (e.g., the central device 120 from FIG. 1). However, the method described can also be performed by any other suitable configuration of electronic hardware.

In some embodiments the method is performed at a central device (e.g., the central device 120 from FIG. 1) including one or more processors and memory storing one or more programs for execution by the one or more processors.

In some example embodiments, the central device central device (e.g., the device 120 in FIG. 1) detects (502), using a central device central device (e.g., the device 120 in FIG. 1), one or more specialist devices in the area proximate to the central device central device (e.g., the device 120 in FIG. 1).

For example, the central device central device (e.g., the device 120 in FIG. 1) periodically probes the surrounding area by sending out a connection signal that each specialist device (e.g., the device 150 in FIG. 1). In other example embodiments, the central device central device (e.g., the device 120 in FIG. 1) listens for connection broadcasts from a specialist device (e.g., the device 150 in FIG. 1). In yet other examples, the central device central device (e.g., the device 120 in FIG. 1) only surveys for specialist device (e.g., the device 150 in FIG. 1) when specifically instructed to by the user.

In response to detecting a first specialist device, the central device central device (e.g., the device 120 in FIG. 1) initiates (504) a connection with the specialist device (e.g., the device 150 in FIG. 1). For example, the central device central device (e.g., the device 120 in FIG. 1) and the specialist device (e.g., the device 150 in FIG. 1) perform an authentication “handshake” with a series of messages (e.g. SYN and ACK messages) that establishes a connection between the two systems. For example, the specialist device (e.g., the device 150 in FIG. 1) and the central device central device (e.g., the device 120 in FIG. 1) send messages detailing the identities of each device and the structure of the communication between the two.

In some example embodiments, the central device central device (e.g., the device 120 in FIG. 1) accesses (506) a list of capabilities associated with the first specialist device (e.g., the device 150 in FIG. 1). For example, as part of the connection establishment protocol, the specialist device (e.g., the device 150 in FIG. 1) transmits a specialist device identification number that is specific to the specialist device (e.g., the device 150 in FIG. 1).

In some example embodiments, the specialist device the device 150 in FIG. 1) also transmits a list of capabilities associated with the specialist device (e.g., the device 150 in FIG. 1). In other example embodiments, the central device central device (e.g., the device 120 in FIG. 1) uses the received specialist device identification number to retrieve capability information (and information to access said capabilities through APIs and so on) from a third party system through an information network.

In some example embodiments, the central device central device (e.g., the device 120 in FIG. 1) accesses (510) a list of capabilities associated with the central device. In some example embodiments, the list of capabilities of the central device central device (e.g., the device 120 in FIG. 1) is stored at the central device central device (e.g., the device 120 in FIG. 1).

In some example embodiments, the central device central device (e.g., the device 120 in FIG. 1) initiates (510) a first task, wherein the first task includes one or more specific task responsibilities associated with the first task. In some example embodiments, the first task is initiated based on user interaction with the first specialist device. For example, the user activates a camera device (e.g., turns it on) and begins taking pictures. The central device central device (e.g., the device 120 in FIG. 1) identifies the requested task and begins to assign responsibilities to complete the requested task. In other example embodiments, some of the responsibility assignments are predetermined.

In some example embodiments, the first task is initiated based on user interaction with the central device central device (e.g., the device 120 in FIG. 1). For example, the user uses the central device central device (e.g., the device 120 in FIG. 1) to initiate a file transfer to or from the storage device at the central device central device (e.g., the device 120 in FIG. 1).

In some example embodiments, the central device central device (e.g., the device 120 in FIG. 1) determines (512), for each respective specific task responsibility, one or more capabilities associated with completing the respective task responsibility. For example, if the central device central device (e.g., the device 120 in FIG. 1) receives a request to track a user's heartbeat over a period of time, determine whether there are any abnormalities relative to a base, and the upload the entire heartbeat record to a server system, the central device central device (e.g., the device 120 in FIG. 1) determines three different task responsibilities. First, the heartbeat must be measured, second a base heartbeat record needs to be stored and accessed to determine whether there are any significant differences between the reference heartbeat and the recorded heartbeat, and then the data needs to be uploaded to a server system via a network.

In some example embodiments, the central device central device (e.g., the device 120 in FIG. 1) determines (514), for each respective specific task responsibility, whether at least one of the central device and the first specialist device include capabilities associated with completing the respective task responsibility, based on the list of capabilities associated with the central device and the list of capabilities associated with the first specialist device.

For example, if one of the task responsibilities is to store data of a specific amount or size, the central device central device (e.g., the device 120 in FIG. 1) determines whether either the central device central device (e.g., the device 120 in FIG. 1) or the specialist device (e.g., the device 150 in FIG. 1) has enough free storage space to store the data.

FIG. 5B is a flow diagram illustrating a method, in accordance with some example embodiments, for connecting a central device to a specialist device (e.g., specialist devices 150-1 and 150-2 in FIG. 1) to accomplish one or more tasks, in accordance with some embodiments. Each of the operations shown in FIG. 5B may correspond to instructions stored in a computer memory or computer-readable storage medium. Optional operations are indicated by dashed lines (e.g., boxes with dashed-line borders). In some embodiments, the method described in FIG. 5B is performed by the central device central device (e.g., the device 120 in FIG. 1). However, the method described can also be performed by any other suitable configuration of electronic hardware.

In some embodiments the method is performed at a central device central device (e.g., the device 120 in FIG. 1) including one or more processors and memory storing one or more programs for execution by the one or more processors.

In accordance with a determination that the list of capabilities with the first specialist device includes capabilities associated with completing the respective task responsibility, the central device (e.g., the device 120 in FIG. 1) allocates (518) the respective task responsibility to the first specialist device. For example, if the task responsibility is to measure a user's heart rate, and the central device (e.g., the device 120 in FIG. 1) determines that the specialist device (e.g., the device 150 in 1) has the capability to measure a user heartrate, the central device (e.g., the device 120 in FIG. 1) then allocates that the specialist device (e.g., the device 150 in FIG. 1) the task of measuring the heartbeat.

In accordance with a determination that the list of capabilities with the central device includes capabilities associated with completing the respective task responsibility, the server system (e.g., the server system 120 in FIG. 1) allocates (520) the respective task responsibility to the central device.

In accordance with a determination that the list of capabilities with neither the central device nor the first specialist device includes capabilities associated with completing the respective task responsibility, the central device (e.g., the device 120 in FIG. 1) identifies (522) additional specialist devices proximate to the central device. For example, if the task requires a display, and neither the central device (e.g., the device 120 in FIG. 1) or the specialist device (e.g., the device 150 in FIG. 1) has an associated display, the central device (e.g., the device 120 in FIG. 1) will try to identify another nearby specialist device (e.g., the device 150 in FIG. 1) that includes a display.

For each additional identified specialist device, the central device (e.g., the device 120 in FIG. 1) determines (524) whether the additional specialist device includes one or more capabilities associated with completing the respective task responsibility. If one of the additional specialist devices (e.g., the device 150 in FIG. 1) has the appropriate capabilities, the task is allocated to that device.

FIG. 5C is a flow diagram illustrating a method, in accordance with some example embodiments, for connecting a central device to a specialist device (e.g., specialist devices 150-1 and 150-2 in FIG. 1) to accomplish one or more tasks. Each of the operations shown in FIG. 5C may correspond to instructions stored in a computer memory or computer-readable storage medium. Optional operations are indicated by dashed lines (e.g., boxes with dashed-line borders). In some embodiments, the method described in FIG. 5C is performed by the central device (e.g., the device 120 in FIG. 1). However, the method described can also be performed by any other suitable configuration of electronic hardware.

In some embodiments the method is performed at a central device (e.g., the device 120 in FIG. 1) including one or more processors and memory storing one or more programs for execution by the one or more processors.

In some example embodiments, central device (e.g., the device 120 in FIG. 1) allocates (530) one or more specific task responsibilities between the central device and the first specialist device, based at least in part on the list of capabilities associated with the first specialist device.

In some example embodiments, wherein allocating one or more specific task responsibilities between the central device and the first specialist device, further comprises the central device (e.g., the device 120 in FIG. 1) determining (532) determining an available bandwidth available at the central device and the first specialist device. For example, the storage device has a certain amount of throughput. If a particular storage device is currently being used at close to its maximum capacity, the central device (e.g., the device 120 in FIG. 1) should consider other storage devices.

In some example embodiments, the central device (e.g., the device 120 in FIG. 1) allocates (534) the one or more specific task responsibilities between the central device and the first specialist device based, at least in part, on the bandwidth available at the first specialist device and the central device. This is especially important if more than one available device has a needed capability. In that case, the central device (e.g., the device 120 in FIG. 1) may select the device with the most available bandwidth to effectively load balance.

In some example embodiments, the central device (e.g., the device 120 in FIG. 1) allocates (536) one or more specific task responsibilities to the central device based at least in part on the list of capabilities associated with the central device.

### Software Architecture

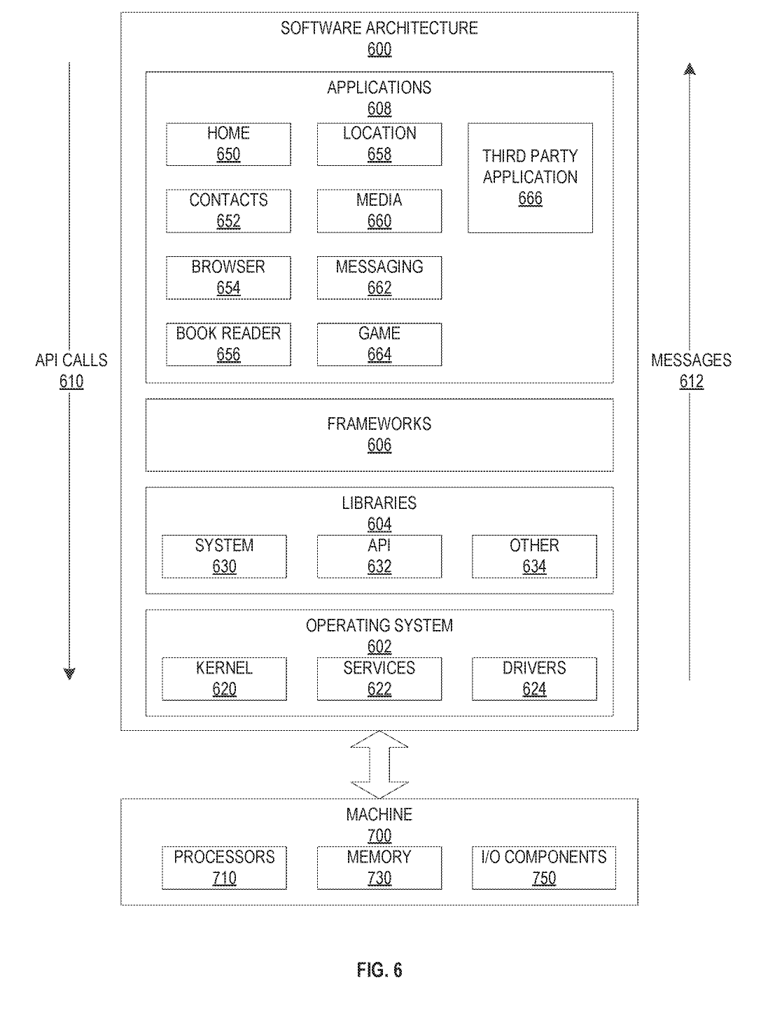

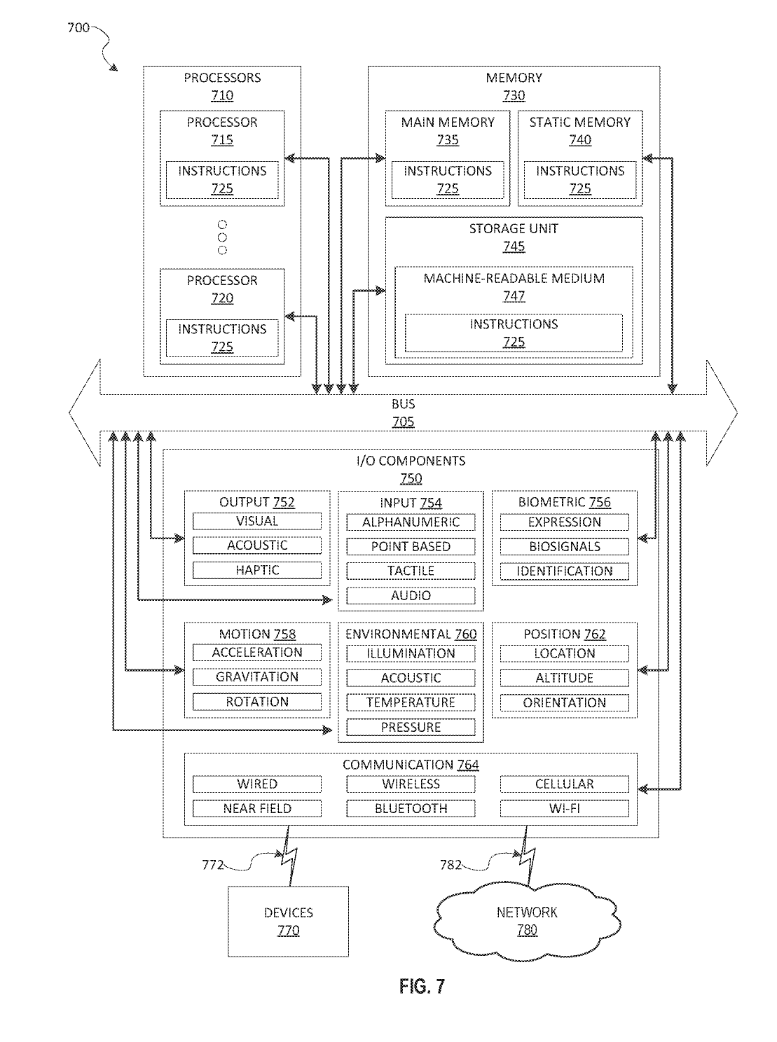

FIG. 6 is a block diagram illustrating an architecture of software 600, which may be installed on any one or more of the devices of FIG. 1 (e.g., third party systems 150). FIG. 6 is merely anon-limiting example of a software architecture that can be used in various computer systems described herein and it will be appreciated that many other architectures may be implemented to facilitate the functionality described herein. The software 600 may be executing on hardware such as machine 700 of FIG. 7 that includes processors 710, memory 730, and I/O components 750. In the example architecture of FIG. 6, the software 600 may be conceptualized as a stack of layers where each layer may provide particular functionality. For example, the software 600 may include layers such as an operating system 602, libraries 604, frameworks 606, and applications 608. Operationally, the applications 608 may invoke application programming interface (API) calls 610 through the software stack and receive messages 612 in response to the API calls 610.

The operating system 602 may manage hardware resources and provide common services. The operating system 602 may include, for example, a kernel 620, services 622, and drivers 624. The kernel 620 may act as an abstraction layer between the hardware and the other software layers. For example, the kernel 620 may be responsible for memory management, processor management (e.g., scheduling), component management, networking, security settings, and so on. The services 622 may provide other common services for the other software layers. The drivers 624 may be responsible for controlling and/or interfacing with the underlying hardware. For instance, the drivers 624 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth.

The libraries 604 may provide a low-level common infrastructure that may be utilized by the applications 608. The libraries 604 may include system libraries 630 (e.g., C standard library) that may provide functions such as memory allocation functions, string manipulation functions, mathematic functions, and the like. In addition, the libraries 604 may include APT libraries 632 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 604 may also include a wide variety of other libraries 634 to provide many other APIs to the applications 608.

The frameworks 606 may provide a high-level common infrastructure that may be utilized by the applications 608. For example, the frameworks 606 may provide various graphic user interface (GUI) functions, high-level resource management, high-level location services, and so forth. The frameworks 606 may provide a broad spectrum of other APIs that may be utilized by the applications 608, some of which may be specific to a particular operating system or platform.

The applications 608 include a home application 650, a contacts application 652, a browser application 654, a book reader application 656, a location application 658, a media application 660, a messaging application 662, a game application 664, and a broad assortment of other applications such as third party application 666. In a specific example, the third party application 666 (e.g., an application developed using the Android™ or iOS™ software development kit (SDK) by an entity other than the vendor of the particular platform) may be mobile software running on a mobile operating system such as iOS™, Android™, Windows® Phone, or other mobile operating systems. In this example, the third party application 666 may invoke the API calls 610 provided by the mobile operating system 602 to facilitate functionality described herein.

### Example Machine Architecture and Machine-Readable Medium

FIG. 7 is a block diagram illustrating components of a machine 700, according to some example embodiments, able to read instructions from a machine-readable medium (e.g., a machine-readable storage medium) and perform any one or more of the methodologies discussed herein. Specifically, FIG. 7 shows a diagrammatic representation of the machine 700 in the example form of a computer system, within which instructions 725 (e.g., software, a program, an application, an applet, an app, or other executable code) for causing the machine 700 to perform any one or more of the methodologies discussed herein may be executed. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but be not limited to, a server computer, a client computer, a PC, a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 725, sequentially or otherwise, that specify actions to be taken by machine 700. Further, while only a single machine 700 is illustrated, the term “machine” shall also be taken to include a collection of machines 700 that individually or jointly execute the instructions 725 to perform any one or more of the methodologies discussed herein.

The machine 700 may include processors 710, memory 730, and I/O components 750, which may be configured to communicate with each other via a bus 705. In an example embodiment, the processors 710 (e.g., a CPU, a Reduced instruction Set Computing (RISC) processor, a Complex instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 715 and processor 720 that may execute instructions 725. The term “processor” is intended to include a multi-core processor that may comprise two or more independent processors (also referred to as “cores”) that may execute instructions contemporaneously. Although FIG. 7 shows multiple processors 710, the machine 700 may include a single processor with a single core, a single processor with multiple cores (e.g., a multi-core process), multiple processors with a single core, multiple processors with multiples cores, or any combination thereof.

The memory 730 may include a main memory 735, a static memory 740, and a storage unit 745 accessible to the processors 710 via the bus 705. The storage unit 745 may include a machine-readable medium 747 on which are stored the instructions 725 embodying any one or more of the methodologies or functions described herein. The instructions 725 may also reside, completely or at least partially, within the main memory 735, within the static memory 740, within at least one of the processors 710 (e.g., within the processor's cache memory), or any suitable combination thereof, during execution thereof by the machine 700. Accordingly, the main memory 735, static memory 740, and the processors 710 may be considered as machine-readable media 747.

As used herein, the term “memory” refers to a machine-readable medium 747 able to store data temporarily or permanently and may be taken to include, but not be limited to, random-access memory (RAM), read-only memory (ROM), buffer memory, flash memory, and cache memory. While the machine-readable medium 747 is shown in an example embodiment to be a single medium, the term “machine-readable medium” should be taken to include a single medium or multiple media (e.g., a centralized or distributed database, or associated caches and servers) able to store instructions 725. The term “machine-readable medium” shall also be taken to include any medium, or combination of multiple media, that is capable of storing instructions (e.g., instructions 725) for execution by a machine (e.g., machine 700), such that the instructions, when executed by one or more processors of the machine 700 (e.g., processors 710), cause the machine 700 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” shall accordingly be taken to include, but not be limited to, one or more data repositories in the form of a solid-state memory (e.g., flash memory), an optical medium, a magnetic medium, other non-volatile memory (e.g., Erasable Programmable Read-Only Memory (EPROM)), or any suitable combination thereof. The term “machine-readable medium” specifically excludes non-statutory signals per se.

The I/O components 750 may include a wide variety of components to receive input, provide and/or produce output, transmit information, exchange information, capture measurements, and so on. It will be appreciated that the I/O components 750 may include many other components that are not shown in FIG. 7. In various example embodiments, the I/O components 750 may include output components 752 and/or input components 754. The output components 752 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 754 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, and/or other pointing instrument), tactile input components (e.g., a physical button, a touch screen that provide location and force of touches or touch gestures, and/or other tactile input components), audio input components (e.g., a microphone), and the like.

In further example embodiments, the I/O components 750 may include biometric components 756, motion components 758, environmental components 760, and/or position components 762 among a wide array of other components. For example, the biometric components 756 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, finger print identification, or electroencephalogram based identification), and the like. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), and/or other components that may provide indications, measurements, and/or signals corresponding to a surrounding physical environment. The position components 762 may include location sensor components (e.g., a GPS receiver component), altitude sensor components (e.g., altimeters and/or barometers that detect air pressure from which altitude may be derived), orientation sensor components (e.g., magnetometers), and the like.

Communication may he implemented using a wide variety of technologies. The I/O components 750 may include communication components 764 operable to couple the machine 700 to a network 780 and/or devices 770 via coupling 782 and coupling 772 respectively. For example, the communication components 764 may include a network interface component or other suitable device to interface with the network 780. In further examples, communication components 764 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 770 may be another machine and/or any of a wide variety of peripheral devices (e.g., a peripheral device coupled via a USB).

Moreover, the communication components 764 may detect identifiers and/or include components operable to detect identifiers. For example, the communication components 764 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF48, Ultra Code, UCC RSS-2D bar code, and other optical codes), acoustic detection components (e.g., microphones to identify tagged audio signals), and so on. In additional, a variety of information may be derived via the communication components 764 such as location via Internet Protocol (IP) geo-location, location via Wi-Fi® signal triangulation, location via detecting a NFC beacon signal that may indicate a particular location, and so forth.

### Transmission Medium

In various example embodiments, one or more portions of the network 780 may be an ad hoc network, an intranet, an extranet, a virtual private network (VPN), a LAN, a wireless LAN (WLAN), a WAN, a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network and the coupling 782 may be a Code Division Multiple Access (CDMA) connection, a Global System for Mobile communications (GSM) connection, or other type of cellular or wireless coupling. In this example, the coupling 782 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 725 may be transmitted and/or received over the network 780 using a transmission medium via a network interface device (e.g., a network interface component included in the communication components 764) and utilizing any one of a number of well-known transfer protocols (e.g., hypertext transfer protocol (HTTP)). Similarly, the instructions 725 may be transmitted and/or received using a transmission medium via the coupling 772 (e.g., a peer-to-peer coupling) to devices 770. The term “transmission medium” shall be taken to include any intangible medium that is capable of storing, encoding, or carrying instructions 725 for execution by the machine 700, and includes digital or analog communications signals or other intangible medium to facilitate communication of such software.

Furthermore, the machine-readable medium 747 is non-transitory (in other words, not having any transitory signals) in that it does not embody a propagating signal. However, labeling the machine-readable medium 747 as “non-transitory” should not be construed to mean that the medium is incapable of movement; the medium 747 should be considered as being transportable from one physical location to another. Additionally, since the machine-readable medium 747 is tangible, the medium 747 may be considered to be a machine-readable device.

### Term Usage

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may he referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
receiving, at a central device, a request to perform a first task that requires multiple specialist device;
determining one or more specialist devices currently available to the central device,
for each respective specialist device available to the current device, determining a list of capabilities associated with the respective specialist device;
determining one or more specific task responsibilities associated with the first task; and
allocating one or more specific task responsibilities between the central device and the one or more specialist devices, based at least in part on the list of capabilities associated with each specialist device in the one or more specialist devices.

2. The method of claim 1, wherein the first task is initiated based on user interaction with the central device.

3. The method of claim 1, wherein the first task is initiated based on user interaction with a specialist device.

4. The method of claim 1, further comprising;
accessing a list of capabilities associated with the central device.

5. The method of claim 4, further comprising allocating the one or more specific task responsibilities to the central device based at least in part on the list of capabilities associated with the central device.

6. The method of claim 4, further comprising, determining, for each respective specific task responsibility, one or more capabilities associated with completing the respective task responsibility.

7. The method of claim 6, further comprising, determining, for each respective specific task responsibility, whether at least one of the central device and the one or more specialist devices include capabilities associated with completing the respective task responsibility, based on the list of capabilities associated with the central device and the list of capabilities associated with the first specialist device.

8. The method of claim 7, further comprising:
in accordance with a determination that the list of capabilities with each specialist device includes capabilities associated with completing the respective task responsibility, allocating the respective task responsibility to the specialist device has capabilities in the list of capabilities.

9. The method of claim 7, further comprising:
in accordance with a determination that the list of capabilities with the central device includes capabilities associated with completing the respective task responsibility, allocating the respective task responsibility to the central device.

10. The method of claim 7, further comprising:
in accordance with a determination that the list of capabilities with neither the central device nor the one or more specialist devices includes capabilities associated with completing the respective task responsibility, identifying additional specialist devices proximate to the central device; and
for each additional specialist device, determining whether the additional specialist device includes one or more capabilities associated with completing the respective task responsibility.

11. The method of claim 1, wherein allocating one or more specific task responsibilities between the central device and the first specialist device, further comprises:
determining an available bandwidth available at the central device and the one or more specialist devices; and
allocating the one or more specific task responsibilities between the central device and the first specialist device based, at least in part, on the bandwidth available at the first specialist device and the central device.

12. The method of claim 1, further comprising;
transmitting one or more stored user preferences to a first specialist device.

13. The method of claim 1, further comprising;
detecting, using a central device, one or more specialist devices in the area proximate to the central device;
in response to detecting a first specialist device, initiating a connection with the first specialist device;

[symbol]

14. The method of claim 1, wherein the received task requires two or more specialist devices to be completed.

15. A specialist device comprising:
one or more processors;
memory; and
one or more programs stored in the memory, the one or more programs comprising instructions for:
receiving, from a central device, one or more task responsibilities associated with a capability of the specialist device;
generating data associated with performing a task responsibilities; and transmitting the generated data to the central device for storage.

16. The system of claim 13, further comprising;
receiving one or more stored user preferences from the central device.

17. A non-transitory computer-readable storage medium storing instructions that, when executed by the one or more processors of a machine, cause the machine to perform operations comprising:
detecting, using a central device, one or more specialist devices in the area proximate to the central device;
in response to detecting a first specialist device, initiating a connection with the specialist device;
accessing a list of capabilities associated with the first specialist device;
initiating a first task, wherein the first task includes one or more specific task responsibilities associated with the first task; and
allocating one or more specific task responsibilities between the central device and the first specialist device, based at least in part on the list of capabilities associated with the first specialist device.

18. The non-transitory computer-readable storage medium of claim 17, further comprising, determining, for each respective specific task responsibility, one or more capabilities associated with completing the respective task responsibility.

19. The non-transitory computer-readable storage medium of claim 18, further comprising, determining, for each respective specific task responsibility, whether at least one of the central device and the first specialist device include capabilities associated with completing the respective task responsibility, based on the list of capabilities associated with the central device and the list of capabilities associated with the first specialist device.

20. The non-transitory cornputer-readable storage medium of claim 17, further comprising;
transmitting one or more stored user preferences to a first specialist device.
